(19) United States
(12) Patent Application Publication
(10) Pub. No.: US 2003/0089623 A1
(43) Pub. Date: May 15, 2003

(54) Chemical sensor

(76) Inventors: Robert Peat, Longcot (GB); Hedley Graham Rhodes, Andover (GB); Andrew Derek Turner, Abingdon (GB)

Correspondence Address: Law Offices of William H Holt, First Floor Unit 2, 1423 Powhatan Street, Alexandria, VA, 22314, US

(21) Appl. No.: 10/220,572

(22) PCT Filed: Feb. 22, 2001
(86) PCT No.: PCT/GB01/00793

(30) Foreign Application Priority Data
Mar. 2, 2000 (GB) 0004930.4
Aug. 17, 2000 (GB) 0020231.7

(51) Int. Cl. G01N 27/416

(52) U.S. Cl. 205/775; 204/422

(57) ABSTRACT

A sensor for detecting chemical properties of a liquid, for example in an oil well, includes a glass pH electrode (22a) and a reference electrode (22c). The glass electrode (22a) consists of a narrow sensor electrode (30) on the surface of an electrically insulating substrate (20), a layer of glass (36) covering the sensor electrode (30), and two cleaning electrodes (32, 33) one extending along each side of the sensor electrode along its entire sensing length. The cleaning electrodes (32, 33) are not covered by the layer of glass, and are no more than 3 mm apart from each other. Application of a voltage between them generates gas bubbles by electrolysis that dislodge any fouling from the glass electrode (22a). The sensor electrode (30) may be of zigzag form, with the cleaning electrodes (32,33) interdigitated between the successive parts of the zigzag. A hydrophilic membrane (24) of sulphonated microporous PVdF provides further protection against fouling of the electrodes (22) by oil. This provides a compact, solid state sensor, which can be cleaned in situ.

This invention relates to an electrical sensor for detecting properties of a liquid, in particular chemical properties, for example for measuring pH, and to the use of such a sensor.

Various electrical sensors are known, such as glass electrodes for measuring pH. Operation of a glass electrode requires the aqueous phase to contact the electrode, so problems can arise in an environment where the electrode may be exposed to non-aqueous liquids and be fouled by deposits of silt or scale or by a coating of oil. U.S. Pat. No. 5,162,077 (Bryan et al.) suggests that fouling can be removed from the membrane of a pH sensor by providing two electrodes spaced apart from each other in the process solution adjacent to the membrane. WO99/56120 (AEA Technology) describes a sensor module suitable for use in an environment such as an oil well in which there is an aqueous liquid and an immiscible liquid, for detecting chemical properties of the aqueous liquid, the module comprising an electrically insulating substrate carrying at least one electrochemical sensor electrode for a chemical species, and a reference electrode; such a sensor is referred to below as a “sensor module of the downhole type.” The sensor electrodes are protected by a microporous barrier of a material which is readily wetted by water, for example steel or glass; and at least one cleaning electrode is arranged adjacent to this barrier. There is a space between the sensor electrodes and the barrier. Fouling is removed by applying a current between the cleaning electrodes, for example for 1 minute or less, the gas bubbles generated by electrolysis removing the fouling. However, problems have been found to arise if the oil cut is greater than about 60%.

According to the present invention there is provided a sensor module of the downhole type with improved means to protect at least one of the electrodes from the immiscible liquid. The protection means may comprise two cleaning electrodes, one extending along each side of the electrode to be protected along its entire sensing length, supported by the substrate and exposed to the liquid of the environment, and no more than 3 mm apart from each other.

The electrode to be protected may be a glass electrode, that is to say it may be a metallic sensor electrode covered by a layer of glass. The layer of glass may cover the substrate only in the immediate vicinity of the sensor electrode, in which case the cleaning electrodes may be on the surface of the substrate. Alternatively, the layer of glass may cover more of the substrate, in which case the cleaning electrodes may be on the surface of the glass layer. The sensor electrode is desirably of zigzag form, so a long length of sensing electrode is provided in a small area of substrate, and in this case the cleaning electrodes may be interdigitated between the successive parts of the zigzag. The separation between the two cleaning electrodes is preferably considerably less than 3 mm, and may be less than 1 mm; the sensor electrode is preferably considerably narrower than 1 mm, and may be less than 0.2 mm wide.

The layer of glass must be an ion conductive glass, of a type suitable for use in pH electrodes. Some glasses may also respond to other ions in the liquid, and these ions can therefore interfere with measurement of pH. Consequently, if pH is to be measured, the glass must be selected in accordance with the expected composition of the liquid so as to minimize any such interference. A sensor of the invention may incorporate two such glass electrodes, with the layers of glass being of different compositions, so that the concentration of another ion in the liquid can be monitored from its interference with the measurement of pH by one of the glass electrodes.

Fouling on the surface of the glass covering the sensing electrode can be removed by applying a brief electrical pulse between the cleaning electrodes. The cleaning effect is primarily due to the bubbles generated by electrolysis. If the liquid is saline, this brief cleaning pulse will cause a pH change (the pH increases, due to generation of chlorine), and hence enables operation of the pH sensor to be monitored.

Alternatively, or additionally, in a sensor module of the downhole type, the protection means may also include a microporous barrier to separate the reference electrode and/or the or each electrochemical sensor electrode from the environment of the module, the microporous barrier comprising a polymeric film of thickness less than 1 mm of a polymeric material that is stable in the said environment, and that has a non-zero zeta potential throughout the pH range from pH 7 to pH 2. Such a barrier is preferentially wetted by any water that may be present in the environment, so it may prevent fouling by oil of the electrodes protected by it.

The polymeric film is preferably of thickness in the range 0.05 mm to 0.30 mm, more preferably in the range 0.1 mm to 0.2 mm, as such films are flexible but sufficiently strong to withstand handling. It must be liquid permeable, and the pores are preferably of size in the range 0.01 μm to 10 μm, more preferably in the range 0.1 μm to 1 μm. The polymer from which the film is made may for example be a copolymer or homopolymer of vinylidene fluoride, or a polymer of tetrafluoroethylene, whose surface has been treated for example by sulphonation to provide the necessary zeta potential. The zeta potential relates to the surface charge when the polymer is in aqueous solution, and can be expected to vary with the pH of the solution. The magnitude of the zeta potential is indicative of the degree to which the polymer is wetted by water, and if the circumstances are such that the zeta potential becomes zero then the polymer will tend to be wetted by the non-aqueous phase. Preferably the polymeric material has a non-zero zeta potential throughout the pH range pH 8 to pH 1.

Preferably the polymeric film is immediately adjacent to the or each electrochemical sensor electrode, as this minimises the time delay before the sensors react to any changes in the environment. Even in the presence of an emulsion in the environment, the water phase will tend to be absorbed by the membrane (because it is sufficiently hydrophilic), and the water in the membrane provides an electrically conducting link between different electrodes. The liquid adjacent to the electrodes is thus water from the environment, absorbed by the microporous polymer film.

The microporous barrier may also be covered by a liquid-permeable protective cover such as a metal mesh, to prevent damage from any sand particles. This may be arranged adjacent to an external counter electrode, so any fouling deposits on the mesh can be cleaned off by application of a brief electrical pulse between the mesh and the counter electrode.

The sensor module preferably comprises a variety of non-liquid electrochemical sensors, for example a solid state pH electrode such as a glass electrode, a solid state chloride-ion sensing electrode, and a reference electrode. The reference electrode may comprise a second solid-state chloride-ion sensing electrode, coated with a material, such as a gel or polymer, containing a substantially constant concentration of chloride ions. All of these electrochemical sensing electrodes may be separated from the environment by the microporous polymer film. The sensor may also comprise a temperature sensor, such as a platinum resistance thermometer. Electrodes may also be provided on either side of such sensing electrodes, so any fouling deposits on or in the microporous polymer film can be cleaned off by application of a brief electrical pulse between these side electrodes.

The reference electrode may comprise successive layers of silver, silver chloride, and an ion-conducting barrier. The barrier might for example comprise an organic polymer containing a chloride salt, for example polyvinylidene fluoride or radiation cross-linked poly(ethylene oxide), or an inorganic material such as a compressed pellet of potassium chloride and alumina. Such an electrode provides a constant voltage, because there is a dynamic equilibrium between the silver, the silver chloride, and the chloride ion activity in the ion-conducting barrier. Alternatively the silver and silver chloride may be replaced by a pseudo-reference, such as palladium and palladium oxide, between which no thermodynamic equilibrium can be identified with an ion in the barrier, but which maintains a constant potential difference between the reference electrode and the barrier.

Thus the invention also provides a method of measuring at least one chemical property of a liquid, using one or more electrochemical sensors as desribed above. The sensor electrodes may be separated from the liquid by a hydrophilic polymer membrane as described above. The sensor of the invention is applicable downhole within an oil well, and may also be used in other situations in which both an aqueous liquid and an immiscible liquid may occur.

The invention will now be further and more particularly described, by way of example only, and with reference to the accompanying drawings, in which:

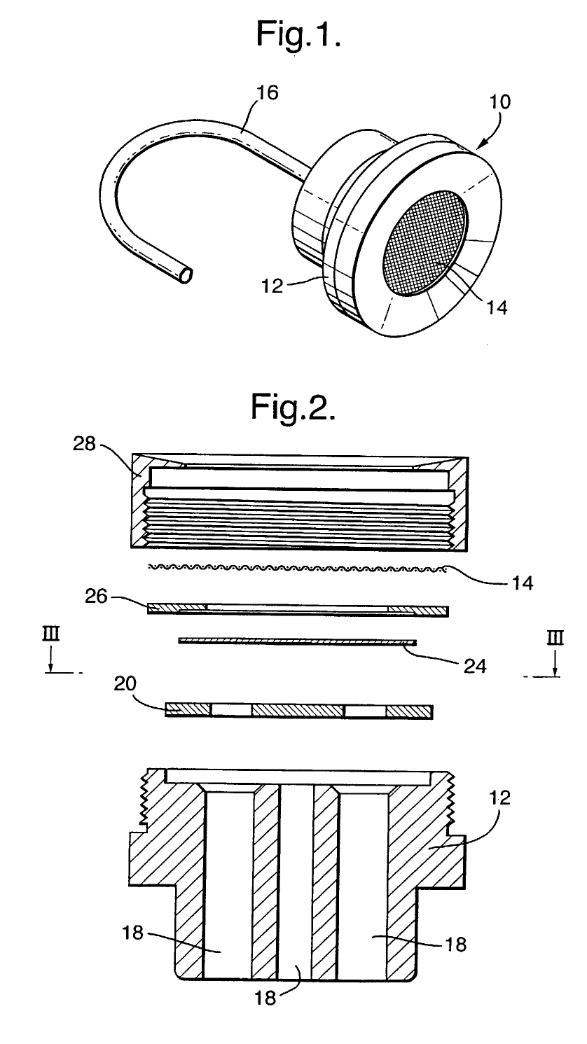

FIG. 1 shows a perspective view of a sensor module for use at depth in an oil well;

FIG. 2 shows an exploded longitudinal sectional view of part of the module of FIG. 1;

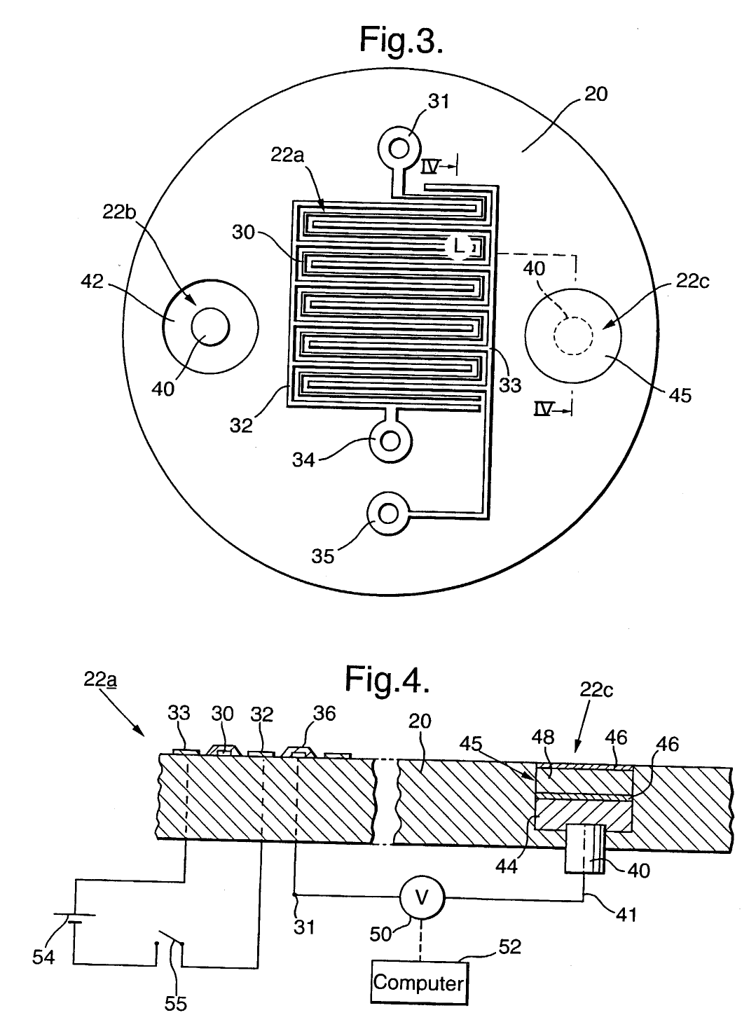

FIG. 3 shows a plan view corresponding to the view on the line III-III of FIG. 2, also showing the arrangement of the sensing electrodes; and

FIG. 4 shows a sectional view on the line IV-IV of FIG. 3.

Referring now to FIG. 1, a sensor module 10 comprises a generally cylindrical stainless-steel housing 12 with an open end covered by a coarse stainless-steel wire mesh 14. The other end of the housing 12 encloses electronic circuitry (not shown) connected to an external electrical cable 16.

Referring now to FIG. 2, the housing 12 defines a number of through-holes 18 for electrical leads (not shown), and a circular ceramic plate 20 carrying sensor elements 22 (shown in FIG. 3) locates in a shallow recess at the upper end of the housing 12 as shown, the electrical leads being connected to the sensor elements 22. The plate 20 is glued into this recess. Above this plate 20 is a 125 μm thick microporous membrane 24 of sulphonated polyvinylidene fluoride (PVdF) that is glued to the top surface of the plate 20 in regions where no elements 22 are present. Above the membrane 24 is an annular washer 26 of sulphonated polyvinylidene fluoride, which separates the membrane 24 from the protective mesh 14. The mesh 14 and the washer 26 are secured to the housing 12 by a threaded sleeve 28 with an internal clamping lip; the sleeve 28 may be of an insulator such as sulphonated PVdF, or of a conductor such as titanium.

Referring now to FIG. 3, the plate 20 and the sensor elements 22 are shown in plan. In this example there are three sensor elements: a pH electrode 22a, a chloride-ion electrode 22b and a reference electrode 22c. The pH electrode 22a consists of a zigzag platinum strip 30 of width 0.1 mm (and total length about 60 mm), and with an electrical contact 31 at one end, printed on the surface of the ceramic plate 20; as shown in FIG. 4, which shows part of the pH electrode 22a in section, a coating of pH electrode glass 36 of width 0.2 mm and of thickness 0.08 mm covers the entire length of the strip 30, so as to extend onto the ceramic 20 on each side of the strip 30, and it also covers the contact 31 similarly. The chloride-ion electrode 22b consists of a cylindrical pellet 40 of silver chloride powder (with a polymer binder) of diameter 2 mm and of length 3 mm, with a silver wire attached to its lower end; the pellet 40 is enclosed in an insulating sleeve 42 glued into a circular hole in the plate 20 so that the upper end of the pellet 40 is flush with the top surface of the plate 20.

Referring also to FIG. 4, the reference electrode 22c consists of another cylindrical pellet 40 of silver chloride powder with a silver wire 41 attached to its lower end (identical to that in the electrode 22b), the upper end being coated with a non-porous reference layer 44 about 0.7 mm thick comprising a PVdF/lithium chloride mixture, to provide a constant concentration of chloride ions. Above this is a barrier layer 45 about 0.8 mm thick. As shown in FIG. 4, the barrier layer 45 consists of two non-porous sheets 46 comprising cation-selective polymer between which is a non-porous layer 48 about 0.5 mm thick comprising PVdF/lithium perchlorate mixture to act as a salt bridge. The electrode 22c is glued with an epoxy resin into a hole in the plate 20 so the upper surface of the barrier layer 45 is flush with the top surface of the plate 20.

The reference layer 44 of the reference electrode 22c is made by forming a stack of five microporous PVdF membranes (e.g. a Durapore membrane—this being a trade mark of Millipore), saturating them with a solution of lithium chloride and PVdF in N-methyl pyrrolidone (NMP), and then allowing the N-methyl pyrrolidone to evaporate. A suitable microporous membrane is 125 μm thick and of porosity about 70%, the pores being of size about 0.22 μm. The barrier layer 45 of the reference electrode 22c is made in a similar way. Two microporous PVdF membranes are saturated with a solution of a sulphonated perfluorinated polymer (Nafion—a trade mark of Du Pont) in ethanol, and the ethanol is evaporated to form the sheets 46; the resulting sheets 46 are permeable to cations but not to anions. A stack of four microporous PVdF membranes are saturated with a solution of lithium perchlorate and PVdF in NMP, and the NMP is evaporated, to form the layer 48. The sheets 46 are then bonded to the top and bottom of the layer 48 using NMP as a solvent. The reference layer 44 and the barrier layer 45 are bonded together in the same way. Thus in each layer 44, 45 the PVdF microporous membranes act as a supporting matrix, and enable the layers to be bonded together.

As shown in FIG. 3, comb-shaped cleaning electrodes 32 and 33 are arranged adjacent to the zigzag strip 30 of the pH electrode 22a, with the teeth of the combs interdigitated between successive parts of the zigzag. The electrodes 32 and 33 are also of platinum, printed on the surface of the ceramic plate 20, and are of width about 0.2 mm, but they are not covered by the pH electrode glass 36, and each has an electrical contact 34, 35 at one end. Each straight part of the glass-covered strip 30 consequently lies midway between teeth of the cleaning electrodes 32 and 33, and the separation between such teeth is about 0.7 mm.

The electrical connections to the contacts 31, 34 and 35 are through holes in the ceramic plate 20, and are indicated diagrammatically in FIG. 4. A digital voltmeter 50 is connected to measure the voltage between the silver contact 41 of the reference electrode 22c, and the platinum strip 30 of the pH electrode 22a, and to provide corresponding signals to a monitoring device such as a computer 52. A DC power supply 54 of say 2 V is connected via a switch 55 to the contacts 34 and 35, so that at intervals, for example once an hour, a current can be passed between the two electrodes 32 and 33 for a brief period such as 30 s, so as to remove any fouling from the pH electrode 22a. Similar electrical connections are made to the chloride electrode 22b.

The microporous membrane 24 that covers the ceramic plate 20 may be made as follows. A hydrophobic PVdF microporous membrane of thickness 125 μm, porosity about 70%, and pore size 0.22 μm (e.g. Durapore), is immersed at room temperature in oleum, that is to say fuming sulphuric acid, for a period of 19 hours. The colour of the membrane is observed to change gradually from white to amber. The sulphonated membrane is then removed, stood in air for a few hours (to gradually absorb moisture from the atmosphere), and then washed in water and dried. The resulting sulphonated microporous membrane is readily wetted by water, and its zeta potential varies with pH from about −28 mv at pH 7, and 30 mV at pH 2.7, to −84 mV at pH 2. The zeta potential is consequently non-zero throughout the range of pH that is likely to be experienced in an oil well. This may be contrasted with glass (silica) for which the zeta potential becomes zero at pH 2-3, alumina for which the zeta potential typically becomes zero at a pH in the pH 3-6 range depending on the production route, steel (iron oxide) for which the zeta potential becomes zero at pH 5-6, and stainless steel (chromium oxide) for which the zeta potential becomes zero at pH 7.

Thus in use the sensor module 10 is installed for example at depth in an oil well, so the liquid to be monitored contacts the membrane 24 through the mesh 14.

Electrical signals from the sensor elements 22a, 22b and 22c are provided via the electronic circuitry in the base of the housing 12 and the cable 16 to external monitoring equipment (such as the voltmeter 50, and the monitoring computer 52). These signals enable the pH and the chloride ion concentration in the aqueous phase to be monitored. The membrane 24 is sufficiently hydrophilic that as long as some water is present in the environment, whether as a continuous phase or as a discontinuous phase in an emulsion, the membrane will be saturated by water from the environment and the membrane will not be wetted by the oil phase. If the environment contains no aqueous phase, then oil will permeate the membrane 24, but if water again becomes present the water will replace the oil in the membrane 24.

The coarse mesh 14 protects the membrane 24 from damage due to abrasion, for example from sand particles. If the surface of the pH electrode 22a or the surface of the membrane 24 above it becomes fouled with particulate material, then the supply 54 may be connected between the cleaning electrodes 32 and 33 for a brief period, generating hydrogen bubbles which emerge through the pores in the membrane 24 and remove the fouling. The sensing elements 22b and 22c may also be provided with spaced apart cleaning electrodes (not shown) on the upper surface of the ceramic plate 20, to ensure fouling can be removed in a similar fashion from those regions of the membrane 24. At atmospheric pressure a pulse duration of about 5 s is usually sufficient, but at higher pressures the bubbles are smaller, and slightly longer pulses are required; for example at 34 MPa the pulse might be as long as 60 s. Operation of this cleaning process may be under the control of the monitoring computer 52.

It will be appreciated that a sensor module may differ from that described above while remaining within the scope of the present invention. The body housing 12 may be of a different material such as a nickel/chromium/ iron alloy e.g. Inconel. The washer 26 may be omitted, so the mesh 14 is directly in contact with the microporous membrane 24. The membrane 24 that covers the sensor elements may be hydrophilic as a result of chemical groups other than the sulphonate groups described above, and may be based on a polymer such as poly tetrafluoroethylene rather than PVdF. Furthermore the membrane 24 might be arranged to cover only a part of the plate 20, for example leaving the pH electrode 22a exposed, relying on the use of the cleaning electrodes 32, 33 to remove any fouling from it.

In particular the sensor elements may differ from those described above, and might incorporate other types of sensor such as a temperature sensor, or a sensor for a different ion. Furthermore the chemical composition of the reference electrode may differ from that described above, for example the reference layer 44 may comprise a layer of vinylidene fluoride/hexafluoropropylene copolymer containing a chloride salt. The layers 44 and 45 are shown as being the same diameter, but instead the barrier layer 45 might be of larger diameter. In another alternative the reference layer 44 may be of inorganic material, for example a compressed pellet of alumina and lithium chloride. Furthermore there might be more than one glass electrode, with glasses of different compositions; if these two glass electrode respond differently to changes in pH then one can act as a reference electrode for the other. The polymer binder of the silver chloride in the chloride-ion electrode 22b may be a powder of sulphonated PVdF, so the silver chloride is less susceptible to fouling by oil.

1. A method for detecting chemical properties of an aqueous liquid, suitable for use in an environment that also contains an immiscible liquid, the method comprising contacting the liquid with a module comprising at least one electrochemical sensor electrode (22a, 22b) for a chemical species, and a reference electrode (22c), and means to protect at least one of the electrodes from the immiscible liquid, the protection means comprising:
a) a microporous barrier (24) to separate at least one of the electrodes (22) from the environment, the barrier comprising a polymeric film of thickness less than 1 mm of a polymeric material that is stable in the said environment, and that has a non-zero zeta potential throughout the pH range from pH 2 to pH 7, and/or
b) two cleaning electrodes (32, 33), one extending along each side of the electrode (30) to be protected along its entire sensing length, exposed to the liquid of the environment, and no more than 3 mm apart from each other.

2. An electrical sensor module for detecting chemical properties of an aqueous liquid, suitable for use in an environment that also contains an immiscible liquid, the module comprising an electrically insulating substrate (20) carrying at least one electrochemical sensor electrode (22a, 22b) for a chemical species, and a reference electrode (22c), and means to protect at least one of the electrodes from the immiscible liquid, the protection means comprising:
a) a microporous barrier (24) to separate at least one of the electrodes (22) from the environment, the barrier comprising a polymeric film of thickness less than 1 mm of a polymeric material that is stable in the said environment, and that has a non-zero zeta potential throughout the pH range from pH 2 to pH 7, and/or
b) two cleaning electrodes (32, 33), one extending along each side of the electrode (30) to be protected along its entire sensing length, supported by the substrate (20) and exposed to the liquid of the environment, and no more than 3 mm apart from each other.

3. An electrical sensor module as claimed in claim 2 wherein the sensor electrode (30) is of zigzag form, and the cleaning electrodes (32, 33) are interdigitated between successive parts of the zigzag.

4. An electrical sensor module as claimed in claim 2 or claim 3 wherein the reference electrode (22c) comprises a solid-state anion-sensing electrode, covered with a layer (44) containing a substantially constant concentration of the anions.

5. An electrical sensor module as claimed in claim 4 wherein the anion layer (44) is covered by a barrier layer (46) that is selectively permeable only to cations.

6. An electrical sensor module as claimed in any one of claims 2 to 5 wherein the polymeric film (24) has a porosity in the range 50 to 90%.

7. An electrical sensor module as claimed in any one of claims 2 to 6 wherein the non-zero zeta potential of the polymeric film (24) is due to sulphonate groups.

8. An electrical sensor module as claimed in any one of claims 2 to 7 wherein the polymeric film (24) is immediately adjacent to the electrode or electrodes (22).

9. An electrical sensor module as claimed in any one of claims 2 to 8 wherein the entire exposed surface of at least one sensing electrode (30) is covered by an ion-conductive glass (36) so as to be sensitive to changes in pH.

10. An electrical sensor module as claimed in claim 9 comprising two such sensing electrodes covered by ion-conductive glass, the layers of glass being of different compositions to enable the concentration of another ion to be monitored.

11. An electrical sensor module as claimed in any one of claims 2 to 10 also comprising a chloride-ion sensitive electrode (22b) comprising a pellet of compressed solid chloride material with a binder, wherein the binder is a polymeric material that is stable in the said environment, and that has a non-zero zeta potential throughout the pH range from pH 2 to pH 7.

12. A method of detecting chemical properties of a liquid using a sensor module as claimed in any one of claims 2 to 11.
